(19) United States
(12) Patent Application Publication
(10) Pub. No.: US 2015/0372895 A1
(43) Pub. Date: Dec. 24, 2015

(54) Proactive Change of Communication Models

(71) Applicant: Telefonaktiebolaget L M Ericsson (publ), Stockholm (SE)

(72) Inventors: Manoj PRASANNA KUMAR, Chennai (IN); Subramanian Shivashankar, Chennai (IN)

(73) Assignee: Telefonaktiebolaget L M Ericsson (publ), Stockholm (SE)

(21) Appl. No.: 14/310,198

(22) Filed: Jun. 20, 2014

(51) Int. Cl. H04L 12/26; H04L 12/24

(52) U.S. Cl. CPC H04L 43/16; H04L 41/147; H04L 41/0672; H04L 43/0811

(57) ABSTRACT

The invention concerns a method, arrangement and computer program product for handling communication between at least two applications in a communication network with the aid of at least one communication queue, the arrangement comprising a processor acting on computer instructions whereby said arrangement is operative to receive, in at least one common default communication queue, messages from a variety of applications according to a default communication model, distribute the messages to destination applications, monitor network communication parameters, predict the status of the communication quality based on the monitored network communication parameters, compare the predicted status with at least one communication failure criterion, select a corresponding relief communication model if the communication failure criterion is fulfilled, and implement the selected relief communication model.

### TECHNICAL FIELD

The invention generally relates to communication between applications a communication network. More particularly, the invention relates to a method, arrangement and computer program product for handling communication between at least two applications in a communication network.

### BACKGROUND

Applications may need to communicate with each other in a number of different environments. As an example a temperature monitoring application in a base station of a mobile communication system may need to communicate with a health monitoring application in a core network of the mobile communication system.

Today, if two or more applications want to communicate with each other, there are numerous Application Programming Interfaces (API's), which aid in creating a fan-out or pub-sub or task distribution or request-reply model of communication. In the API's available currently, after building applications in one of the above communication models, there is no way to monitor if the chosen communication model is efficient. The systems are not intelligent enough to predict communication failures. Also, if the communication model is to be changed, there is a manual effort needed to restructure the applications using the available API's in the market. In current production environments, communication models are changed only after failures. Proactive steps to prevent communication failures are not taken.

There is therefore a need for a proactive way of handling communication failures between applications communicating with each other.

### SUMMARY

One object of the invention is thus to proactively handle a communication failures between applications communicating with each other.

In a first aspect an arrangement for handling communication between at least two applications in a communication network with the aid of at least one communication queue is provided. The arrangement comprises a processor acting on computer instructions, through which computer instructions the arrangement is, according to a default communication model, configured to receive messages from a variety of applications in at least one common default communication queue and distribute the messages to destination applications. Through the instructions the arrangement is furthermore configured to: monitor network communication parameters, predict the status of the communication quality based on the monitored network communication parameters, and compare the predicted status with at least one communication failure criterion. If then the communication failure criterion is fulfilled a corresponding relief communication model is selected and implemented.

In a second aspect a method for handling communication between at least two applications in a communication network with the aid of at least one communication queue is provided, which method is performed in a communication handling arrangement. In the method messages from a variety of applications according to a default communication model are received in at least one common default communication queue and distributed to destination applications. In the method network communication parameters are also monitored, the status of the communication quality predicted based on the monitored network communication parameters and the predicted status compared with at least one communication failure criterion. If then the communication failure criterion is fulfilled a corresponding relief communication model is selected and implemented between the applications.

The object is according to a third aspect achieved through a computer program product for handling data communication between at least two applications in a communication network with the aid of at least one communication queue. The computer program product is provided on a data carrier comprising computer program code which when run in a communication handling arrangement, implements a functionality where messages from a variety of applications are, according to a default communication model, received in at least one common default communication queue and distributed to destination applications. Furthermore, in the implemented functionality network communication parameters are monitored, the status of the communication quality predicted based on the monitored network communication parameters and the predicted status compared with at least one communication failure criterion. If then the communication failure criterion is fulfilled a corresponding relief communication model is selected and implemented between the applications.

The invention according to the above-mentioned aspects has a number of advantages. The efficiency of the communication model used between applications is continuously monitored. The communication model between applications is restructured automatically and proactively in case a failure is predicted. The complexity of restructuring the communication model is abstracted from the applications. Communication failures are thus proactively avoided.

There may be a model of the dependency between the parameters. In an advantageous variation of the first and second aspects, the predicting of the status may be based on predicting the value of a parameter based on the temporal history of this parameter and the temporal history of parameters it depends on. The predicting may be performed using a statistical classifier, such as a Bayes classifier.

The parameters may comprise mean time between failures, mean time to recover, input message rate and output message rate.

In another advantageous variation of the first aspect, the arrangement is further operative to determine an own availability based on mean time to recover, input message rate and output message rate. In this case the status may comprise the mean time between failure and the availability.

In a corresponding variation of the second aspect, the method further comprises determining the own availability based on mean time to recover, input message rate and output message rate, in which case the status may comprise the mean time between failure and the availability.

In a further variation of the first and second aspects, a first relief communication model implemented when a first communication failure criterion is fulfilled comprises allocating a separate communication queue to the communication between two applications and monitoring the usage of every such separate communication queue.

In this case the first communication failure criterion may be fulfilled when the predicted mean time between failure is below a first MTBF threshold but above a second lower MTBF threshold and the availability is below a first availability threshold but above a second lower availability threshold.

In another variation of the first and second aspects, a second relief communication model implemented when a second communication failure criterion is fulfilled comprises providing the applications with connectivity data allowing them to connect directly to each other.

In this case the second communication failure criterion may be fulfilled when the predicted mean time between failure is below the second MTBF threshold but above a third lower MTBF threshold and the availability is below a second availability threshold but above a third lower availability threshold.

In yet another variation of the first and second aspects, a third relief communication model implemented when a third communication failure criterion is fulfilled comprises allocating a separate communication queue to the communication between two applications to a device separate from the arrangement and providing this separate device with data enabling monitoring the usage of every such separate communication queue allocated to it.

In this case the third communication failure criterion may be fulfilled when the predicted mean time between failure is below the third MTBF threshold and the availability (A) is below the third availability threshold.

According to another variation of the first aspect, the communication handling arrangement leaves a relief communication model once the corresponding communication failure criterion is no longer at hand.

According to a corresponding variation of the second aspect, the method further comprises leaving a relief communication model once the corresponding communication failure criterion is no longer at hand. In this case it is further possible to implement another relief communication model if the corresponding communication failure criterion is fulfilled or to return to the default communication model.

According to a corresponding variation of the second aspect, the method further comprises leaving a relief communication model once the corresponding communication failure criterion is no longer at hand. This may be complimented by implementing another relief communication model if the corresponding communication failure criterion is fulfilled or returning to the default communication model.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The invention will now be described in more detail in relation to the enclosed drawings, in which:

FIG. 1 schematically shows a number of applications communicating with each other via a communication handling arrangement comprising a monitoring module, a queue factory, a prediction module and model handler,

FIG. 2 schematically shows one way of realizing the communication handling arrangement,

FIG. 3 schematically shows the queue factory communicating with the applications according to a default communication model,

FIG. 4 schematically shows the dependencies between various network parameters being monitored by the communication handling arrangement,

FIG. 5 shows a flow chart of method steps in a method for handling communication between at least two applications in a communication network according to a first embodiment,

FIG. 6 shows a flow chart of method steps in a method for handling communication between at least two applications in a communication network according to a second embodiment,

FIG. 7, schematically shows the implementation of a first relief communication model,

FIG. 8 schematically shows the communication handling arrangement and applications when communicating according to the first relief communication model,

FIG. 9 schematically shows the implementation of a second relief communication model,

FIG. 10 schematically shows the implementation of a third relief communication model, and

FIG. 11 shows a computer program product comprising a data carrier with computer program code for implementing the functionality of the communication handling arrangement.

### DETAILED DESCRIPTION

In the following description, for purposes of explanation and not limitation, specific details are set forth such as particular architectures, interfaces, techniques, etc. in order to provide a thorough understanding of the invention. However, it will be apparent to those skilled in the art that the invention may be practiced in other embodiments that depart from these specific details. In other instances, detailed descriptions of well-known arrangements, devices, circuits and methods are omitted so as not to obscure the description of the invention with unnecessary detail.

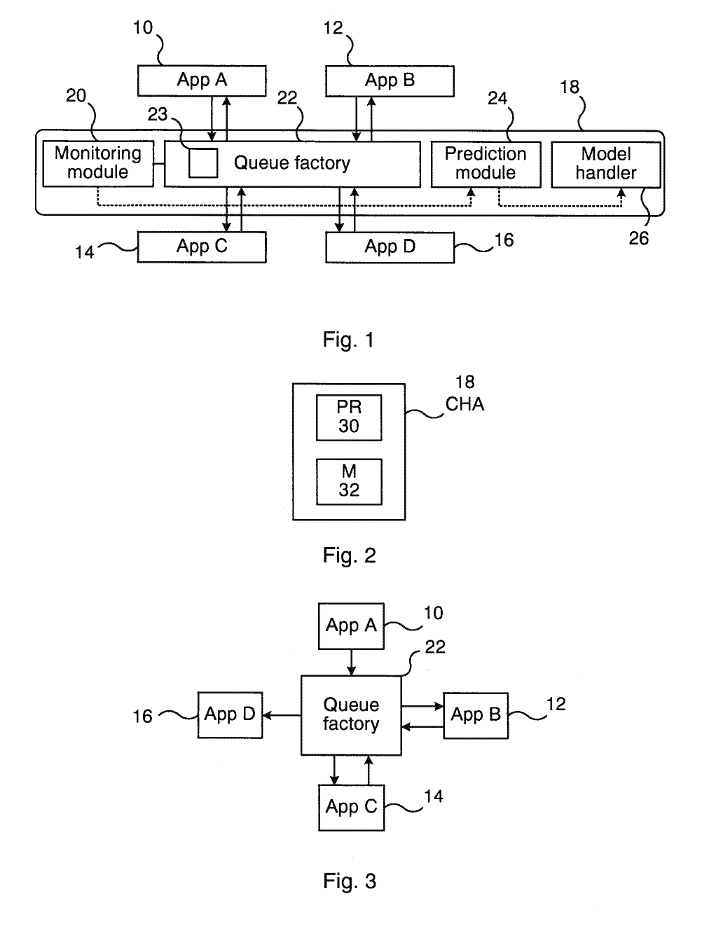

FIG. 1 schematically shows a communication handling arrangement 18 for the handling of the communication between a number of applications. There is here a first application A 10, a second application B 12, a third application C 14 and a fourth application D 16. The applications furthermore communicate with the communication handling arrangement via a communication network (not shown), which may be a part of a mobile communication system. An example of applications in such a system is a temperature monitoring application in a base station of an access network set to communicate with a health monitoring application in a core network.

The applications may be provided in one or more machines or devices. Also the communication handling arrangement may be provided in one or more machines or devices. These latter machines or devices are however different from those in which the applications are provided.

An application may send messages that are destined for another application. However, according to a default communication scheme employed in the communication network, the communication handling arrangement is to handle the distribution of these messages. Therefore the applications all send their messages to a queue factory 22 in the communication handling arrangement 18, where the queue factory 22 in turn ensures that the messages are distributed to the destination applications. The messages may here be Transfer Control Protocol/Internet Protocol (TCP/IP) messages. For this purpose the queue factory 22 is also provided with one or more communication queues, where one 23 is shown in FIG. 1. There may here be one communication queue provided for the communication between two applications. There may also be one communication queue per application. All messages from one application intended for other applications may be received in one communication queue. It is also possible with the opposite situation. i.e. that there is one communication queue for all messages destined for a certain application. As yet another alternative it is possible there is as single default communication queue where all messages are received and from where all messages are sent. Each communication queue may be realized as a buffer. All these are variations of one or more default communication queues provided in the queue factory 22.

The arrangement 18 furthermore has a monitoring module 20, which monitors network parameters and reports to a prediction module 24. There prediction module 24 in turn predicts communication/socket failure based on the monitored network parameters, for instance using machine learning techniques. There is also a model handler 26, which gets the predicted values of communication/socket failure from the prediction module and restructures the communication model between applications if required.

FIG. 2 shows a block schematic of one way of realizing the communication handling arrangement CHA 18 with one or more of it's modules. The communication handling arrangement 26 may be provided in the form of a processor 30 connected to a program memory M 32. The program memory 32 may comprise a number of computer instructions implementing the functionality, i.e. the various modules of the communication handling arrangement 18 and the processor 30 implements this functionality when acting on these instructions. It can thus be seen that the combination of processor 30 and memory 32 provides the communication handling arrangement 18.

The communication handling arrangement may with advantage be provided on one or more separate devices, such as servers. In this case the monitoring module 20, queue factory 22, prediction module 24 and model handler 26 are provided on the same physical device, which may be the same server. However in some special circumstances some of the functionally of one or more of these modules may be moved or provided on another physical device. In such a case this other physical device, which may also be a server, may also be part of the communication handling arrangement.

FIG. 3 shows a block schematic that outlines a default communication model. It is as an example possible that the first application 10 sends messages intended for the second application 12, the second application sends messages intended for the third application 14 and the third application sends messages intended for the fourth application 16. It can be seen that all applications that send messages send these to the queue factory 22 of the communication handling arrangement, which in turn distributes them to the destination applications. It can thus be seen that the first application sends messages to the queue factory 22, which distributes them to the second application 12. The second application sends messages to the queue factory 22, which distributes them to the third application 14. The third application 14 does finally also send messages to the queue factory 22, which in turn distributes them to the fourth application 16.

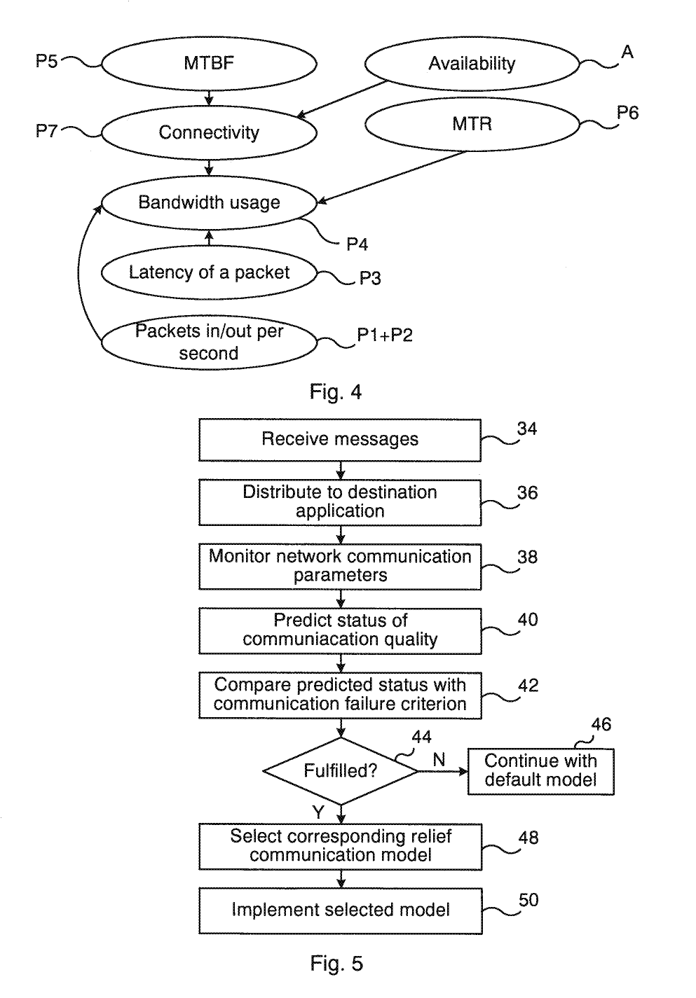

As mentioned earlier, the monitoring module 20 monitors network parameters. FIG. 4 shows seven different network parameters that are being monitored as well as how they are dependent on each other.

There is a first network parameter P1 which is a message rate into to the arrangement 18 or rather the rate at which messages are received in communication queues associated with the communication handling arrangement, a second network parameter P2, which is the message rate out of the arrangement 18 or rather the rate at which messages are sent out from communication queues associated with the communication handling arrangement. The rates may be messages per second. As mentioned above the rates may be the rates into and out of at least one communication queue, which if there are several queues may be an average rate of all the queues. Furthermore in the default communication model all communication queries for which such rates are calculated are default communication queues in the queue factory 22. As will be seen later some or all of these communication queues may according different relief communication models be provided in other locations than the queue factory. There is a third parameter P3 which is the latency of a message, which may be time taken by a message to reach it's destination. The latency may therefore be the delay between when a message is sent from a sending application to when it is received in a receiving application. There is a fourth parameter P4 which is the bandwidth usage of the communication handling arrangement, i.e. the bandwidth occupied by the messages coming into and out from the communication handling arrangement. The bandwidth usage may be expressed as the bandwidth usage per second. There is also a fifth parameter P5, which is the Mean Time Between Failures (MTBF). This is the average Time between two successive communication failures, where a communication failure may be a failure related to a communication queue. It could be caused by an overflowing queue or a sudden increase in speed of incoming messages to a queue. It could also be a failure in an application that receives messages. There is a sixth parameter P6, which is the Mean Tine to Recover (MTR). This is a parameter defining the time it takes for the communication handling arrangement to restart after a communication failure. There is finally a seventh parameter P7, which is connectivity. Connectivity is defined by data such as the status of the device hosting the queue factory (Alive/Dead) and ping statistics.

There is also an availability A of the queue factory 22, which is determined by the monitoring module based on some of the above mentioned parameters. The availability is thus a combination of some of the monitored parameters.

As can be seen in FIG. 4 some parameters have a dependency on other parameters according to some type of dependency model. The seventh parameter P7, connectivity, can here be seen as depending on the fifth parameter P5 as well as on the availability A. In a similar manner it can be seen that the fourth parameter P4 depends on the first and second parameters P1 and P2 message input/output rate, on the third parameter P3 latency, on the sixth parameter P6 MTR and on the seventh parameter P7 connectivity.

As mentioned earlier, the communication between applications may break down for different reasons. It is for this reason of interest to monitor the communication of the system, especially with regard to the centralized queue factory, and predict if a communication failure will occur. If one is predicted it is then possible to take appropriate countermeasures, which in this case involves employing one or more relief communication models.

Aspects of the invention are directed toward such prediction and the implementation of suitable countermeasures when a communication breakdown is predicted with regard to at least some applications.

Now a first embodiment will be described with reference also being made also to FIG. 5, which shows a flow chart of method steps in a method for handling communication between at least two applications in the communication network.

The applications 10, 12, 14 and 16 are all set to communicate with the queue factory 22 of the communication handling arrangement 18. Furthermore the applications are set to communicate with the communication handling arrangement 18 according to the default communication model in which all messages pass through the queue factory 22 and more particularly through the one or more default communication queues 23 of this queue factory 22. The queue factory 22 may because of this use a “star” or “hub and spoke” architecture. This means that although messages from an application are intended for other applications, these messages will still be sent to the queue factory 22. Every application is thus connected to the central Queue Factory in the default communication model. No application sends messages directly to the other application. All the communication is passed through the Queue Factory 22.

The queue factory 22 thus receives the messages, in at least one common default communication queue 23, from a variety of applications according to the default communication model, step 34.

The queue factory then distributes the messages in the one of more default communication queues to the destination applications, step 36. The queue factory may route the messages to the right applications based on business criteria such as “queue name”, “routing key”, “topic”, “message properties” etc.

At the same time the monitoring module 20 monitors network communication parameters of the traffic in and out from the queue factory 22, step 38. It may here continuously monitor one or more of the network communication parameters P1-P7 and report the monitored parameters to the prediction module 24. It may also determine the availability A and report this to the prediction module 24. The availability A may in this case be determined as

$$Availability = 100 - \frac{unfunctional\_time + disconnected\_time}{Total\_time \_monitored} * 100 ( \% )$$

where the unfunctional time may be MTR during the time of monitoring and the disconnected time the difference between the message input rate and message output rate during the same time of monitoring.

The prediction module will then predict the status of the communication quality based on the monitored network communication parameters, step 40. It may more particularly predict the status based on the availability and the fifth parameter P5, MTBF. For this reason the status may comprise two elements: a predicted MTBF and a predicted availability. As the availability A may be determined based on the first, second and sixth parameters P1, P2 and P6, it can be seen that the status may be predicted based also on these parameters.

In the prediction machine learning techniques may also be employed. It is for instance possible to use a model of dependency between the parameters, where FIG. 4 shows one exemplifying such model. The prediction module may in this case predict the value of a parameter based on the temporal history of this parameter and the temporal history of parameters it depends on. It can therefore be seen that even more parameters than P5, P1, P2 and P6 may be used in the prediction. Any suitable classifier may be used for the predicting, where one example is a Bayes classifier. It is also possible that there are no dependencies, in which case a parameter may be predicted solely based on the own temporal history.

After having predicted the communication status, the prediction module 24 informs the model handler 26.

Thereafter the model handler 26 compares the predicted status with at least one communication failure criterion, step 42, and determines that the default communication model is to be continued, step 46, if the communication failure criterion is not fulfilled, step 44. In this case the model handler 26 may or may not inform the queue factory 22 of the result of the investigation. If however the communication failure criterion is fulfilled, step 44, the model handler 26 selects a corresponding relief communication model, step 48, and informs the queue factory 22, which then implements the selected model, step 50.

The criterion may be fulfilled if for instance the MTBF crosses a MTBF threshold and the availability crosses an availability threshold both of which are associated with the communication failure. The relief communication model may involve various degrees of distributing the handling of the communication from the default communication queue 23 in the queue factory 22. It may involve allocating an exclusive communication queue to the communication between two applications, where one or more exclusive communication queues are provided in at least one device that is separate from the device comprising the queue factory 22 and the monitoring module 20. A relief communication model may also involve monitoring the usage of every such exclusive communication queue either in the monitoring module or in one or monitoring functions provided in the one or more devices comprising exclusive communication queues. A relief communication model may also involve providing the applications with connectivity data allowing the applications to connect directly to each other.

As the communication parameters are continuously monitored, the status prediction and communication failure criterion comparison may continue after a relief communication model has been implemented. This also means that if the predicted status later on no longer fulfils the communication failure criterion for which a relief communication model was selected and implemented, it is possible to switch to another relief communication model, the failure communication criterion of which the predicted status now fulfils. As an alternative it is possible to return to the default communication model.

The above describe operation has a number of advantages. The efficiency of the used communication model between applications is continuously monitored. The communication model between applications is restructured automatically and proactively in case a failure is predicted. The complexity of restructuring the communication model is abstracted from the applications. A high availability of messages is also ensured. Communication failures are thus proactively avoided.

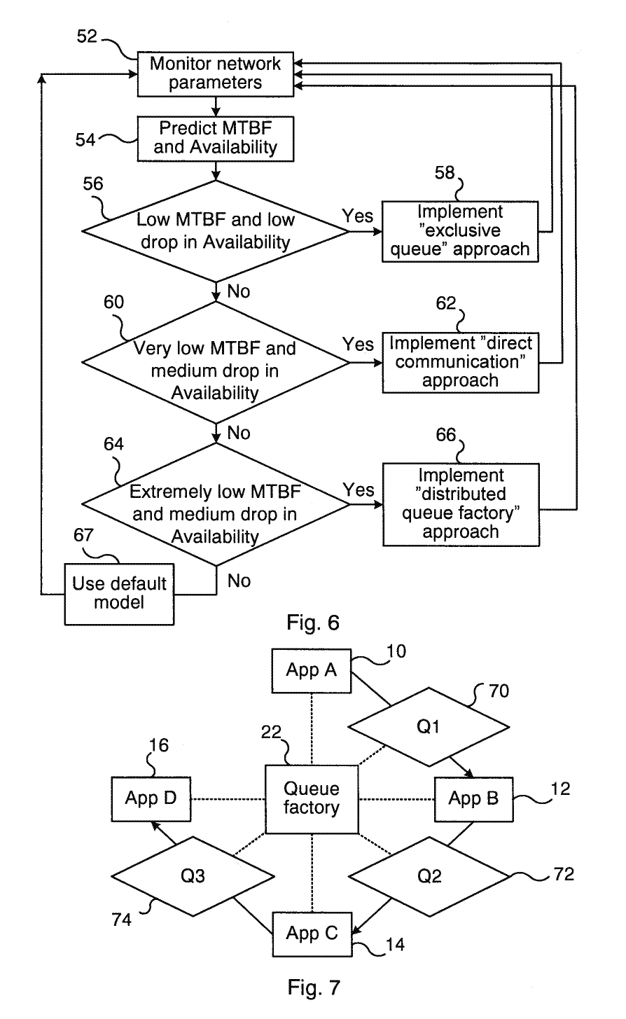

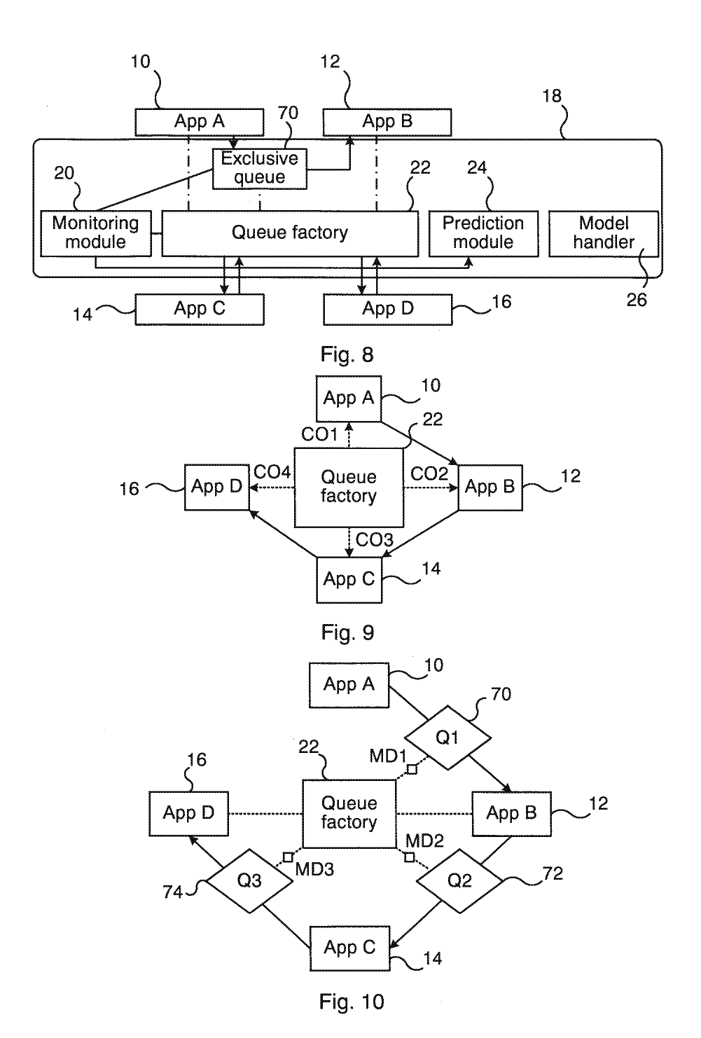

Now a second embodiment will be described with reference again being made to FIG. 1-4, as well as with reference to FIG. 6, which shows a flow chart of method steps in a method for handling communication between at least two applications in the communication network, to FIG. 7, which schematically shows an implementation of a first relief communication model, to FIG. 8, which schematically shows the communication handling arrangement and applications when communicating according to the first relief communication model, to FIG. 9, which schematically shows the implementation of a second relief communication model and to FIG. 10, which schematically shows the implementation of a third relief communication model.

In the example given here the communication according to FIG. 3 is yet again assumed, where the first application 10 sends messages intended for the second application 12, the second application 12 sends messages intended for the third application 14 and the third application 14 sends messages intended for the fourth application 16. The messages may once again be TCP/IP messages. The first and second application 10 and 12 thereby form a first sender-receiver pair, the second and third application 12 and 14 thereby form a second sender-receiver pair and the third and fourth application 14 and 16 form a third sender-receiver pair. However, it has to be stressed that this is merely one example given in order to describe the functioning of the communication handling arrangement 18. An application may for instance send messages to several applications and may also receive messages from several applications including those to which it sends messages.

As in the first embodiment the default communication model is initially in place, where the applications 10, 12, 14 and 16 communicate via the queue factory 22 and the at least one default communication queue 23. There may be thus be one separate default queue provided for each of the above mentioned sender-receiver pairs. There may also be a single default queue 23 for all communication. There may also be a hybrid in-between, where some sender-receiver pairs share the same default communication buffers. However, in order to simplify the understanding of this second embodiment, one default communication buffer 23 is shown and described.

Also in this case, the queue factory may use the “star” or “hub and spoke” architecture, where all the communication is passed through the Queue Factory 22. One reason for this may be that an application doesn't need to have any idea about the location of other applications. The only address that applications then needs is the network address of the Queue Factory.

This means that when an application such as the first application 10 sends messages intended for another application such as the second application 12, it sends these messages addressed to the physical device comprising the queue factory 22. The queue factory 22 then routes the messages to the right applications. The routing may be based on business criteria, such as “queue name”, “routing key”, “topic”, “message properties” etc. Also, the lifetime of message sender and message receiver don't have to overlap. A sender application can push messages to the queue factory 22 and then terminate. The messages will be available for the receiver application any time later. This means that if the sender application fails, the messages that are already in the queue factory 22 will also be retained.

The monitoring module 20 again continuously monitors the network parameters, step 52. It also determines the availability based on the monitored network parameters, where the network parameters may be the same as in the first embodiment. The availability may also be determined in the same way as in the first embodiment. The monitoring module 20 then reports the results to the prediction module 24.

Thereafter prediction module 24 predicts the status of the communication quality based on the monitored network communication parameters. In this second embodiment it does this through predicting the availability A and the fifth parameter P5, MTBF, step 54.

In the prediction the model of dependency between the parameters may be employed where FIG. 4, shows one exemplifying such model. The prediction module may in this case predict the future value of a parameter based on the current value and temporal history of the parameter itself and the temporal history of parameters it depends on. The prediction of MTBF and Availability of a future time instance may thus made based on their values of a current instance as well as their values and the values of parameters on which they depend of one or more previous time instances. The number of previous time instances to use may here be set by a window W and the parameter on which another parameter depends may be termed a child parameter. Therefore the prediction of a parameter depending on a number of child parameters, where the prediction is made at a time t, may be defined as:

P(Parameter^{X}ₜ|Dependency Structure)=P(Parameter^{X}ₜ|Parameter^{X}_{t-W . . . t-1},Child Parameters_{t-W . . . t-1})

It can in the example of FIG. 4 be seen that the fourth parameter P4 has a dependency of the first, second and third parameters P1, P2 and P3, that the sixth and seventh parameters P6 and P7 have a dependency of the fourth parameter P4 and both the availability A and the fifth parameter P5 depend on the seventh parameter P7.

Therefore in this example the fourth parameter P4 may be predicted based on its current value, its own temporal history and the temporal history of the first, second, third, sixth and seventh parameters, P1, P2, P3, P6 and P7, where the first and second parameters may be combined. In a similar manner the seventh parameter P7 may be predicted based on its current value, its own temporal history and the temporal history of the fifth parameter P5 and the availability A.

For the given set of parameters and dependency structure, the procedure could be repeated in the order of topology sorting over nodes (starting from P4) to avoid difference in results due to node ordering.

One possible ordering is: P4→P3→P1+P2→P6→P7→A→P5. Another possible ordering is P3→P4→P1+P2→P6→P7→A→P5.

The above describe scheme may be referred to as creating a stacked network at time “t”. In a stacked network each parameter is a node in a graph, where the availability A may be considered as one parameter and P1+P2 may be considered as another parameter.

P(Parameter^{X}ₜ|Parameter^{X}_{t-W . . . t-1},Child Paramters_{t-W . . . t-1})=θ(Parameter^{X}_{t-W . . . t-1},Child Paramters_{t-W . . . t-1},Child Parametersₜ)

where θ can be any classifier/model of choice. It may for instance be a Bayes classifier.

In this way it can be seen that the prediction of a parameter value may be computed as a function of the temporal history of the own value and the temporal history of dependent parameters according to the node ordering.

After having predicted the communication status, the prediction module 24 then informs the model handler 26.

Thereafter the model handler 26 compares the predicted status with at least one communication failure criterion. In this embodiment there are three criteria to be compared with.

The model handler 26 compares the predicted status with a first communication failure criterion. As the predicted status comprises the predicted MTBF and the predicted availability, the predicted MTBF is compared with a first and second MTBF threshold and the predicted availability is compared with a first and second availability threshold, where the second MTBF threshold is lower than the first MTBF threshold and the second availability threshold is lower than the first availability threshold. If now the predicted mean time between failure P5 is below the first MTBF threshold but above the second MTBF threshold and the availability A is below the first availability threshold but above the second lower availability threshold, step 56, the first communication failure criterion is fulfilled, which may involve a low MTBF and a low drop in availability. Thereby the model handler 26 instructs the queue factory 22 to implement a first relief communication model, which employs an “Exclusive Queue” approach, step 58.

The first relief communication model comprises allocating a separate communication queue to the communication between two applications and monitoring the usage of every such separate communication queue.

How this can be realized is shown in more detail in FIGS. 7 and 8.

The communication model is thus changed to the exclusive queue approach. One exclusive queue is in this case allocated for every pair of applications communicating to each other. As can be seen in FIG. 7, this means that there is created a first exclusive queue Q1 70 for the first sender-receiver pair, a second exclusive queue Q2 72 for the second sender-receiver pair and a third exclusive queue 14 for the third sender-receiver pair, where the first exclusive queue 70 receives the messages from the first application 10 and forwards them to the second application 12, the second exclusive queue 72 receives the messages from the second application 12 and forwards them to the third application and the third exclusive queue 74 receives the messages from the third application 14 and forwards them to the fourth application 16.

Metadata about the queues allocated to the applications is maintained in the central queue factory 22. Meta data may here comprise identifiers of available exclusive queues, i.e. queues that have not been allocated to any applications, identifiers of allocated exclusive queues, identifiers of applications that have been allocated to exclusive queues, data about to which exclusive queues these applications have been allocated, location information of the exclusive queues and location information of the allocated applications. Each queue may be implemented as a separate application set to distribute the messages therein according to the same routing routine used by the default communication queue. It may run on the same machine as one of the applications it is connecting or it may be located on a completely different machine. In some cases, several queues may run on a single machine. In other cases a machine may be dedicated exclusively to host a single queue. For this reason at least some of the sending applications may here receive notice of a new address that is to receive their messages.

Once this communication model is up and running, the monitoring module 20 monitors the usage of exclusive queues as well.

One motivation for using this approach is that the messages are stored in the exclusive queue while the sender is already off and receiver has not yet started. Also, if an application fails, messages that have already been passed to the exclusive queue are not lost. The overhead of two network hops to get message from sender to the receiver is not avoided, but still the load on the central queue factory is reduced.

After having implemented the exclusive queue for one or more of the applications, the monitoring module 20 returns and monitors network parameters, where the monitoring comprises monitoring of the default communication queues 23 in the queue factory 22 as well as any exclusive queues 70, 72 and 74 that have been implemented.

If however the first communication failure criterion was not fulfilled, step 56, the model handler 26 investigates if a second communication failure criterion is fulfilled. As the predicted status comprises the predicted MTBF and the predicted availability, this means that the predicted MTBF is compared with the second and a third MTBF threshold and the predicted availability is compared with the second and a third availability threshold, where the third MTBF threshold is lower than the second MTBF threshold and the third availability threshold is lower than the second availability threshold. If now the predicted mean time between failure P5 is below the second MTBF threshold but above the third MTBF threshold and the availability A is below the second availability threshold but above the third availability threshold, step 60, the second communication failure criterion is fulfilled, which may involve a very low MTBF and a medium drop in availability. Thereby the model handler 26 instructs the queue factory 22 to implement a second relief communication model, which employs a “direct communication” approach, step 62.

The second relief communication model comprises providing the applications with connectivity data allowing them to connect directly to each other.

In this approach, the applications 10, 12, 14 and 16 are registered in the queue factory 22 and allowed to communicate within themselves directly. The queue factory may in this case inform the applications that they are to communicate directly with each other. For example, the second application 12 may have previously registered with the queue factory 22 letting it know that it runs on a server Y. The first application 10 wanting to send a message to the second application 12 may then query the queue factory 22 for the location of the second application 12. Once the queue factory 22 replies that the second application 12 is located on server Y, the first application 10 can create a connection directly to B and send the message. This is schematically outlined in FIG. 9, where the control factory 22 sends connectivity data CD1, CD2, CD3 and CD4 to the different applications 10, 12, 14 and 16, which connectivity data comprise information about how to directly connect to another application.

The motivation to use this approach is to ensure high performance and manageability at the same time.

After having enabled the implementation of the direct communication between one or more of the applications, the monitoring module 20 returns and monitors network parameters, step 52, where the monitoring may comprise monitoring of the default communication queues 23 in the queue factory 22. In this case the monitoring of if the instability has ceased may involve continuously computing availability, MTBF and MTR.

If however the second communication failure criterion was not fulfilled, step 64, then the model handler 26 investigates if a third communication failure criterion is fulfilled. As the predicted status comprises the predicted MTBF and the predicted availability, this means that the predicted MTBF is compared with the third MTBF threshold and the predicted availability is compared with the third availability threshold. If now the predicted mean time between failure P5 is below the third MTBF threshold and the availability A is below the third availability threshold, step 66, the third communication failure criterion is fulfilled, which may involve an extremely low MTBF and a high drop in availability. Thereby the model handler 26 instructs the queue factory 22 to implement a third relief communication model, which employs a “distributed queue factory” approach, step 66.

In this approach, it is very much evident that the central queue factory 22 is failing very often and is becoming a highly critical single point of failure for the system. Hence, in this scenario an exclusive queue is allocated to each pair of applications that communicate to each other. The entire metadata available in the central queue factory 22 is copied to all the machines hosting the exclusive queues. Also in this case the meta data may comprise identifiers of available exclusive queues, identifiers of allocated exclusive queues, identifiers of applications that have been allocated to exclusive queues, data about to which exclusive queues these applications have been allocated, location information of the exclusive queues and location information of the allocated applications. An instance of monitor is created in the machines hosting the exclusive queues. It can thus be seen that just as in the first approach an exclusive queue is provided for each sender-receiver pair. This means that the first exclusive queue Q1 70 is provided between the first and second applications 10 and 12, the second exclusive queue Q2 72 is provided between the second and third applications 12 and 14 and the third exclusive queue Q3 74 is provided between the third and fourth applications 14 and 16. However, as opposed to the first approach the queue factory 22 also provides each of these exclusive queues 70, 72 and 74 with metadata MD1, MD2 and MD3 of all the communicative aspects. Each queue is accompanied by its own network parameter monitoring functionality.

The motivation to use this approach is that even when the central queue factory fails, or an exclusive queue fails, all the applications should not get affected. A portion of the subsystem using other exclusive queues will still function properly and they will have access to their own copy of metadata (in the exclusive queue).

In this approach, any change in metadata in the central queue factory will be broadcasted to all the exclusive queues. If the central queue factory fails, new applications will not be able to register and use the proposed system. However, existing applications may continue to communicate seamlessly.

After having implemented the exclusive queue for one or more of the applications, network parameter monitoring is resumed, step 52. However in this case this is done at the local exclusive queues 70, 72 and 74. The distributed local monitoring functions may then report their results to the prediction module 24 which yet again predicts MTBF and availability, step 54.

If the third communication failure criterion was not fulfilled, step 64, then the model handler 26 concludes that the risk of communication failure is low and therefore decides that the default model is continued to be used, step 67, which may or may not be reported to the queue factory 22 based on which communication model is at hand.

It can here be seen that it is possible that once a relief communication model has been implemented then it is possible to change to another relief communication model in case the predicted status changes. It is also possible to change back to the default communication model. If for instance the model handler 26, when the second relief communication model is in force, sees that the stability of the system is consistent for a threshold period, it may instruct the queue factory 22 to change communication model and perhaps also which communication model to change to. The queue factory 22 may then inform the applications that the second communication model is to be left in favour of the default model or another relief communication model based on the degree of stability. In the case of the first and third relief communication models being in force, the information about leaving the relief communication model will be given to the exclusive queues instead.

The above describe operation has a number of advantages. The efficiency of the used communication model between applications is continuously monitored. The communication model between applications is restructured automatically and proactively in case a failure is predicted. The complexity of restructuring the communication model is abstracted from the applications. A high availability of messages is also ensured. It can thus be seen that communication failures can be proactively avoided.

The communication handling arrangement was in FIG. 8 shown as comprising the at least one of the exclusive queues. It can thus be seen that the one or more devices that are used for implementing exclusive queues according to the first and third relief communication models may be a part of the communication handling arrangement. However, in this case the arrangement comprises at least two distinctly separate devices or machines, where one comprises the queue factory and monitoring module but lacks exclusive queues, and the other comprises one or more of the exclusive queues but not the queue factory or monitoring module. In other variations the exclusive queues are not a part of the communication handling arrangement but entities with which the queue factory of the communication handling arrangement communicates.

The communication handling arrangement 26 may, as was implied initially, be provided in the form one or more processors with associated program memories comprising computer program code with computer program instructions executable by the processor for performing the functionality of the communication handling arrangement.

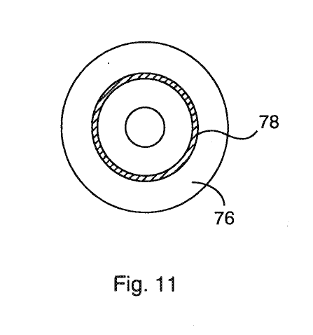

The computer program code of a communication handling arrangement may also be in the form of computer program product for instance in the form of a data carrier, such as a CD ROM disc or a memory stick. In this case the data carrier or memory stick carries a computer program with the computer program code, which will implement the functionality of the above-described communication handling arrangement. One such data carrier 76 with computer program code 78 is schematically shown in FIG. 11.

Furthermore the communication handling arrangement may in some variations be described in means plus function language.

The queue factory may therefore be considered to comprise means for receiving, in at least one common default communication queue, messages from a variety of applications according to a default communication model, means for distributing the messages to destination applications and means for implementing a selected relief communication model.

In a similar manner the monitoring module may be considered to comprise means for monitoring network communication parameters, the prediction module may be considered to comprise means for predicting the status of the communication quality based on the monitored network communication parameters and the model handler may be considered to comprise means for comparing the predicted status with at least one communication failure criterion and means for selecting a corresponding relief communication model if the communication failure criterion is fulfilled.

As there may be model of the dependency between the parameters, the means for predicting the status may comprise means for predicting the status based on predicting the value of a parameter based on the temporal history of this parameter and the temporal history of parameters it depends on.

The parameters may comprise mean time between failures, mean time to recover, input message rate and output message rate. The monitoring module may be considered to comprise means for determining an own availability based on mean time to recover, input message rate and output message rate, where the status comprises the mean time between failure and the availability.

The means for selecting a relief communication model may be considered to comprise means for implementing a first relief communication model when a first communication failure criterion is fulfilled, comprising means for allocating a separate communication queue to the communication between two applications and means for monitoring the usage of every such separate communication queue.

The means for selecting a relief communication model may be considered to comprise means for implementing a second relief communication model when a second communication failure criterion is fulfilled, comprising means for providing the applications with connectivity data allowing them to connect directly to each other.

The means for selecting a relief communication model may be considered to comprise means for implementing a third relief communication model when a third communication failure criterion is fulfilled, comprising means for allocating a separate communication queue to the communication between two applications to a device separate from the arrangement and providing this separate device with data enabling monitoring the usage of every such separate communication queue allocated to it.

The communication handling arrangement may also be considered to comprise means for leaving a relief communication model once a corresponding communication failure criterion is no longer at hand, means for implementing another relief communication model if the corresponding communication failure criterion is fulfilled and means for returning to the default communication model.

While the invention has been described in connection with what is presently considered to be most practical and preferred embodiments, it is to be understood that the invention is not to be limited to the disclosed embodiments, but on the contrary, is intended to cover various modifications and equivalent arrangements. Therefore the invention is only to be limited by the following claims.

1. An arrangement for handling communication between at least two applications in a communication network with the aid of at least one communication queue, the arrangement comprising a processor acting on computer instructions whereby said arrangement is operative to
receive, in at least one common default communication queue, messages from a variety of applications according to a default communication model,
distribute the messages to destination applications,
monitor network communication parameters,
predict the status of the communication quality based on the monitored network communication parameters,
compare the predicted status with at least one communication failure criterion,
select a corresponding relief communication model if the communication failure criterion is fulfilled, and
implement the selected relief communication model.

2. The arrangement according to claim 1, wherein there is a model of the dependency between the parameters and the predicting of the status is based on predicting the value of a parameter based on the temporal history of this parameter and the temporal history of parameters it depends on.

3. The arrangement according to claim 2, wherein the predicting is performed using a statistical classifier, such as a Bayes classifier.

4. The arrangement according to claim 1, wherein the parameters comprise mean time between failures, mean time to recover, input message rate and output message rate, and the arrangement is further operative to determine an own availability based on mean time to recover, input message rate and output message rate, where the status comprises the mean time between failure and the availability.

5. The arrangement according to claim 1, wherein a first relief communication model implemented when a first communication failure criterion is fulfilled comprises allocating a separate communication queue to the communication between two applications and monitoring the usage of every such separate communication queue.

6. The arrangement according to claim 5, wherein the first communication failure criterion is fulfilled when a predicted mean time between failure is below a first MTBF threshold but above a second lower MTBF threshold and an availability is below a first availability threshold but above a second lower availability threshold.

7. The arrangement according to claim 1, wherein a second relief communication model implemented when a second communication failure criterion is fulfilled comprises providing the applications with connectivity data allowing them to connect directly to each other.

8. The arrangement according to claim 7, wherein the second communication failure criterion is fulfilled when a predicted mean time between failure is below a second MTBF threshold but above a third lower MTBF threshold and an availability is below a second availability threshold but above a third lower availability threshold.

9. The arrangement according to claim 1, wherein a third relief communication model implemented when a third communication failure criterion is fulfilled comprises allocating a separate communication queue to the communication between two applications to a device separate from the arrangement and providing this separate device with data enabling monitoring the usage of every such separate communication queue allocated to it.

10. The arrangement according to claim 9, wherein the third communication failure criterion is fulfilled when a predicted mean time between failure is below a third MTBF threshold and an availability is below a third availability threshold.

11. The arrangement according to claim 1, being further operative to leave a relief communication model once the corresponding communication failure criterion is no longer at hand.

12. The arrangement according to claim 11, being further operative to implement another relief communication model if the corresponding communication failure criterion is fulfilled.

13. The arrangement according to claim 11, being further operative to return to the default communication model.

14. A method for handling communication between at least two applications in a communication network with the aid of at least one communication queue, the method being performed in a communication handling arrangement and comprising
receiving, in at least one common default communication queue, messages from a variety of applications according to a default communication model,
distributing the messages to destination applications,
monitoring network communication parameters,
predicting the status of the communication quality based on the monitored network communication parameters,
comparing the predicted status with at least one communication failure criterion,
selecting a corresponding relief communication model if the communication failure criterion is fulfilled, and
implementing the selected relief communication model between the applications.

15. The method according to claim 14, wherein there is a model of the dependency between the parameters and the predicting of the status is based on predicting the value of a parameter based on the temporal history of this parameter and the temporal history of parameters it depends on.

16. The method according to claim 15, wherein the predicting is performed using a statistical classifier, such as a Bayes classifier.

17. The method according to claim 14, wherein the parameters comprise mean time between failures, mean time to recover, input message rate and output message rate, the method further comprising determining the own availability based on mean time to recover, input message rate and output message rate, and the status comprises the mean time between failure and the availability.

18. The method according to claim 14, wherein a first relief communication model implemented when a first communication failure criterion is fulfilled comprises allocating a separate communication queue to the communication between two applications and monitoring the usage of every such separate communication queue.

19. The method according to claim 18, wherein the first communication failure criterion is fulfilled when a predicted mean time between failure is below a first MTBF threshold but above a second lower MTBF threshold and an availability is below a first availability threshold but above a second lower availability threshold.

20. The method according to claim 14, wherein a second relief communication model implemented when a second communication failure criterion is fulfilled comprises providing the applications with connectivity data allowing them to connect directly to each other.

21. The method according to claim 20, wherein the second communication failure criterion is fulfilled when a predicted mean time between failure is below a second MTBF threshold but above a third lower MTBF threshold and an availability is below a second availability threshold but above a third lower availability threshold.

22. The method according to claim 14, wherein a third relief communication model implemented when a third communication failure criterion is fulfilled comprises allocating a separate communication queue to the communication between two applications in a device separate from the communication handling arrangement and providing this separate device with data enabling monitoring the usage of every such separate communication queue allocated to it.

23. The method according to claim 22, wherein the third communication failure criterion is fulfilled when a predicted mean time between failure is below a third MTBF threshold and an availability is below a third availability threshold.

24. The method according to claim 14, further comprising leaving a relief communication model once the corresponding communication failure criterion is no longer at hand.

25. The method according to claim 24, further comprising implementing another relief communication model if the corresponding communication failure criterion is fulfilled.

26. The method according to claim 24, further comprising returning to the default communication model.

27. A computer program product for handling data communication between at least two applications in a communication network with the aid of at least one communication queue,
the computer program product being provided on a data carrier comprising computer program code which when run in a communication handling arrangement, causes the communication handling arrangement to:
receive, in at least one common default communication queue, messages from a variety of applications according to a default communication model,
distribute the messages to destination applications,
monitor network communication parameters,
predict the status of the communication quality based on the monitored network communication parameters,
compare the predicted status with at least one communication failure criterion,
select a corresponding relief communication model if the communication failure criterion is fulfilled, and
implement the selected relief communication model between the applications.
